(19) United States
(12) Patent Application Publication
(10) Pub. No.: US 2018/0293962 A1
(43) Pub. Date: Oct. 11, 2018

(54) DISPLAY DEVICE

(71) Applicants: HKC Corporation Limited, Shenzhen City, Guangdong (CN); Chongqing HKC Optoelectronics Technology Co., Ltd., Chongqing (CN)

(72) Inventor: Chia-Hang LEE, Chongqing (CN)

(21) Appl. No.: 15/555,637

(22) PCT Filed: Apr. 13, 2017
(86) PCT No.: PCT/CN2017/080378

§ 371 Date: Sep. 5, 2017

(30) Foreign Application Priority Data
Dec. 31, 2016 (CN) 201611268173.7

(51) Int. Cl. G09G 5/38; G06F 3/01

(52) U.S. Cl. CPC G09G 5/38; G09G 2354/00; G09G 2320/028; G06F 3/013

(57) ABSTRACT

The present disclosure relates to a display device, including: a display panel; a user position information detection unit, having an image sensor, electrically coupled to a motor control unit, and configured to sense a user image, to obtain eye position information of a user; and an angle adjustment module, coupled to the display panel, and configured to adjust a rotation angle of the display panel according to the eye position information of the user.

### BACKGROUND

### Technical Field

The present disclosure relates to a display device, and in particular, to a flat or curved display device capable of rotating corresponding to an eye position of a user.

### Related Art

In recent years, with the development of technologies, many different display devices such as liquid crystal displays (LCD) or electro luminescence (EL) display devices are widely applied to flat displays. Using LCDs as an example, most LCDs are backlight type LCDs, and each LCD includes an LCD panel and a backlight module. The LCD panel is formed by two transparent substrates and a liquid crystal sealed between the substrates.

With the development of display technologies, in addition to improvements in size and picture quality, appearances of display devices such as curved display devices are also changed. Compared with flat display devices, curved display devices can be made to have a larger size with a same width, and the curved display devices may further provide a better viewing effect. Using a flat television and a curved television as an example, when a viewer moves a line of sight from the center of a screen of the flat television to two external sides, the viewer usually finds a poor visual feeling at an edge of the flat television. Especially, for a conventional flat LCD (regardless of a vertical alignment (VA) type or an in-plane switching (IPS) type) television, during large-angle viewing, the flat LCD television generally has a color difference from viewing at a central viewing angle. This results in degradation of picture quality as a viewing angle increases.

### SUMMARY

To resolve the foregoing technical problem, an objective of the present disclosure is to provide a display device, comprising: a display panel; a user position information detection unit, comprising an image sensor, electrically coupled to a motor control unit, and configured to sense a user image, to obtain eye position information of a user; and an angle adjustment module, coupled to the display panel, and configured to adjust a rotation angle of the display panel according to the eye position information of the user.

Another objective of the present disclosure is to provide a display device, comprising: a display panel; a user position information detection unit, comprising an image sensor, electrically coupled to a motor control unit, and configured to sense a user image, to obtain eye position information of a user, where the user position information detection unit comprises a rotation angle calculation component configured to automatically analyze angle information, and the angle information is an angle and the user deviates from a central plane of the display panel by the angle; and an angle adjustment module, coupled to the display panel, and configured to adjust a rotation angle of the display panel according to the eye position information of the user, where the angle adjustment module comprises: a rotation control mechanism unit, having a gear; and a motor control unit, having a motor, where the motor is connected to the gear, where after receiving the angle information provided by the rotation angle calculation component, the motor control unit converts the angle information to a relative rotation physical quantity, and controls the motor according to the relative rotation physical quantity.

In some embodiments, the display panel in the present disclosure may be a flat display panel, that is, a display panel not curved.

In some embodiments, the display panel in the present disclosure may be a curved display panel.

In some embodiments, the display panel in the present disclosure may be applied to various different displays, for example, an LCD, an organic electro luminescence (OEL) display, an organic light emission diode (OLED) display, a light emission diode (LED) display, a plasma display panel (PDP), a field emission display (FED), a carbon nanotube display, an electronic ink (E-ink) display, an interferometric modulator display (IMD), a micro electro mechanical system display using the Time Multiplexed Optical Shutter (TMOS) technology, or a display using the Electrochromic Display (ECD) technology.

Still another objective of the present disclosure is to provide a display device, comprising: a display panel; and an angle adjustment module, coupled to the display panel, and configured to adjust a rotation angle of the display panel.

The objective of the present disclosure may further be achieved and the technical problem of the present disclosure may further be resolved by using the following technical measure.

Still another objective of the present disclosure is to provide a method for controlling a rotation angle of a display device, including: providing the display device; generating a control signal according to position information of an object image sensed by a user position information detection unit; controlling rotation of a motor of a motor control unit according to the control signal; and simultaneously controlling a rotation angle of a display panel by means of a rotation speed of the rotation control mechanism unit.

In an embodiment of the present disclosure, the display panel includes a cover, having a first curved surface; and a backplane, disposed opposite to the cover, and having a second curved surface.

In an embodiment of the present disclosure, the display panel further includes an LCD panel, disposed between the backplane and the cover.

In an embodiment of the present disclosure, the angle adjustment module includes: a rotation control mechanism unit, having a gear; a motor control unit, having a motor, where the motor is connected to the gear; and a user position information detection unit, having a charge-coupled component, electrically coupled to the motor control unit, and configured to sense an object image.

In an embodiment of the present disclosure, the motor is a step motor.

In an embodiment of the present disclosure, the user position information detection unit includes a rotation angle calculation component configured to automatically analyze an angle a user deviates from a central plane of the display panel by the angle.

In an embodiment of the present disclosure, the user position information detection unit further includes a signal processor configured to analyze a distance and the user deviates from the center of the display by the distance.

In an embodiment of the present disclosure, according to the method, the step of simultaneously controlling a rotation angle of the display panel by means of a rotation speed of the rotation control mechanism unit includes: connecting to the backplane of the display panel by means of the rotation control mechanism unit; adjusting the second curved surface of the backplane by means of rotation of the gear; and adjusting a rotation angle of the second curved surface, to adjust a rotation angle of the first curved surface of the cover.

In an embodiment of the present disclosure, according to the method, the motor is a step motor.

In an embodiment of the present disclosure, according to the method, the user position information detection unit may be a sensor chip or a sensor.

In some embodiments, the display device includes an LCD panel and a backlight module disposed opposite to each other. The LCD panel mainly includes a color filter (CF) substrate, a thin film transistor (TFT) substrate, and a liquid crystal layer sandwiched between the two substrates, where the CF substrate, the TFT substrate, and the liquid crystal layer may form a plurality of pixel units configured in an array. A substrate material of the CF substrate and the TFT substrate may be a glass substrate or a flexible plastic substrate. The CF substrate may be, for example, a glass substrate or a substrate of another material having a CF. The TFT substrate may be, for example, a glass substrate or a substrate of another material having a TFT array. In some embodiments, the CF and the TFT array may be configured on a same substrate.

In some embodiments, the backlight module may be, for example, a side light incident backlight module, disposed opposite to a display panel (for example, the LCD panel), to form the display device (for example, the LCD device). The backlight module may include a backplane, a light source, a light guide plate, a reflection layer, and an optical film. The backplane is configured to assemble the light source, the light guide plate, the reflection layer, and the optical film. The light source is disposed at one side of the light guide plate and configured to emit light to the light guide plate from the side, and the light is guided by the light guide plate. The reflection layer is foil ted between the backplane and the light guide plate, and is configured to reflect the light of the light source. The optical film is disposed on the light guide plate, to improve an optical effect.

In some embodiments, the light source may be, for example, a cold cathode fluorescent lamp (CCFL), a hot cathode fluorescent lamp (HCFL), a light-emitting diode (LED), an organic light emitting diode (OLED), a flat fluorescent lamp (FFL), an EL component, a light bar, a laser light source, or any combination thereof.

In some embodiments, the optical film of the backlight module is, for example, a diffuser, a prism sheet, a turning prism sheet (TPS), a brightness enhancement film (BEF), a dual brightness enhancement film (DBEF), a diffused reflective polarizer film (DRPF), or any combination thereof, and is disposed on the light guide plate, to improve an optical effect of light emission of the light guide plate.

In the present disclosure, the method for controlling a rotation angle of a display can be automatically adjusted according to a change of a user position, so that a rotation angle of a display device is adjusted, and picture quality at a large viewing angle can be further improved for a viewer.

### BRIEF DESCRIPTION OF THE DRAWINGS

FIG. 1a is a schematic exemplary diagram of a television viewing angle;

FIG. 1b is a schematic exemplary diagram of vertical and horizontal color differences;

FIG. 2a is a schematic exemplary diagram of a gamma curved line of a pixel;

FIG. 2b is a schematic exemplary diagram of controlling a gamma curved line of a pixel by means of a voltage;

FIG. 3 is a schematic exemplary diagram of relationships between different viewing angles at which a user views a display and different distances to the display;

FIG. 4 is another schematic exemplary diagram of relationships between different viewing angles at which a user views a display and different distances to the display;

FIG. 5 is a schematic diagram of a display device according to an embodiment of the present disclosure;

FIG. 6 is a flowchart of a method for intelligently controlling a rotation angle of a display device according to an embodiment of the present disclosure;

FIG. 7 is a schematic diagram of detecting a user position by a user position information detection unit according to an embodiment of the present disclosure;

FIG. 8 is a schematic diagram of a display device according to another embodiment of the present disclosure;

FIG. 9 is a schematic view illustrating operation of a rotation control mechanism unit according to an embodiment of the present disclosure;

FIG. 10 is a schematic view illustrating operation of a display device according to an embodiment of the present disclosure; and

FIG. 11 is a schematic diagram of a display device according to an embodiment of the present disclosure.

### DETAILED DESCRIPTION

The following embodiments are described with reference to the accompanying drawings, and are used to exemplify particular embodiments for implementation of the present disclosure. Terms about directions mentioned in the present disclosure, such as “above”, “below”, “front”, “back”, “left”, “right”, “in”, “out”, and “side surface” merely refer to directions of the accompanying drawings. Therefore, the used tennis about directions are used to describe and understand the present disclosure, and are not intended to limit the present disclosure.

The accompanying drawings and the description are considered to be essentially exemplary, rather than limitative. In the figures, units of similar structures are represented by using same numerals. In addition, for understanding and ease of description, a size and a thickness of each component shown in the accompanying drawings are arbitrarily shown, but the present disclosure is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a substrate is described to be “above” “another component”, the component may be directly above the another component, or there may be an intermediate component.

In addition, in this specification, unless otherwise explicitly described to have an opposite meaning, the word “include” is understood as including the component, but not excluding any other component. In addition, in this specification, “above” means that a component is located above or below a target component, but does not mean that the component needs to be located on the top of a gravity direction.

To further describe the technical means used in the present disclosure to achieve the pre-determined invention objective and effects thereof, specific implementations, structures, features, and effects of a display device provided according to the present disclosure are described in detail below with reference to the drawings and preferred embodiments.

In some embodiments, a display panel in the present disclosure may be a flat display panel, that is, a display panel not curved.

In some embodiments, the display panel in the present disclosure may be applied to various different displays, for example, an LCD, an OEL display, an OLED display, a LED display, a PDP, a FED, a carbon nanotube display, an E-ink display, an IMD, a micro electro mechanical system display using the TMOS technology, or a display using the ECD technology.

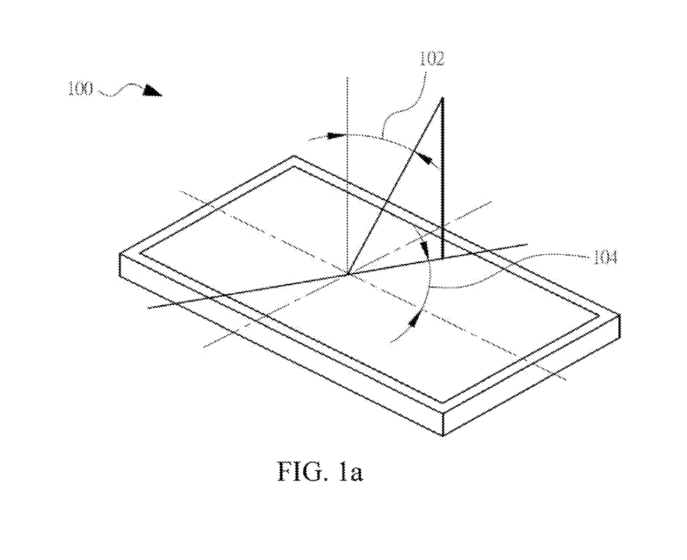

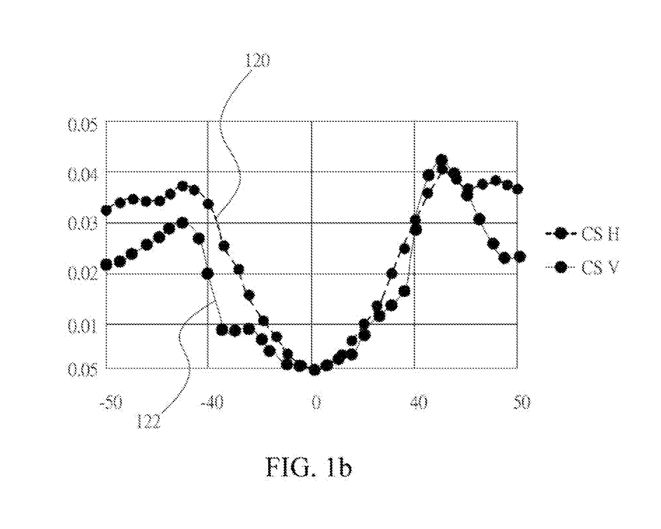

FIG. 1a is a schematic exemplary diagram of a television viewing angle; and FIG. 1b is a schematic exemplary diagram of vertical and horizontal color differences. Referring to FIG. 1a and FIG. 1b, for a television of a VA type or an IPS type, during viewing at a large viewing angle, a flat LCD 100 generally has a horizontal color difference 120 from a normal angle 102 of a central viewing angle and a vertical color difference 122 from a horizontal angle 104 of the central viewing angle. This results in degradation of picture quality as a viewing angle increases.

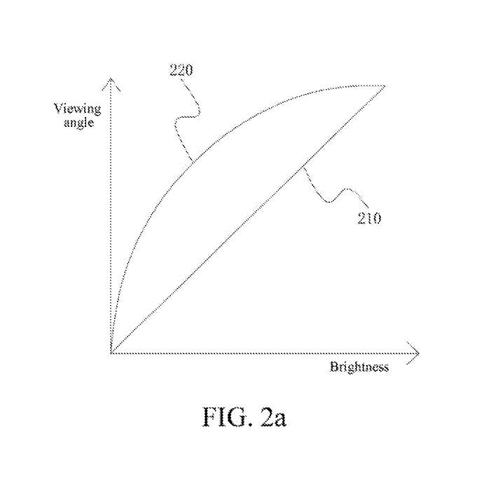

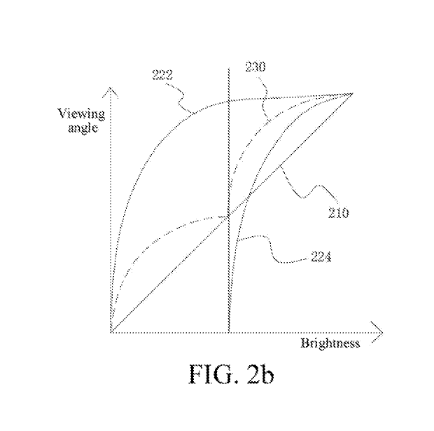

FIG. 2a is a schematic exemplary diagram of a gamma curved line of a pixel; and FIG. 2b is a schematic exemplary diagram of controlling a gamma curved line of a pixel by means of a voltage. Referring to FIG. 2a and FIG. 2b, a conventional manner of improving a viewing angle for a flat LCD is that: A pixel is divided into two subpixels: a subpixel A and a subpixel B; a gamma curved line 222 of the subpixel A and a gamma curved line 224 of the subpixel B are controlled by means of a voltage; and the gamma curved line 222 of the subpixel A and the gamma curved line 224 of the subpixel B are combined into a gamma curved line 230 different from a conventional gamma curved line 220 and close to an ideal gamma curved line 210, so as to compensate and improve a color difference at a side viewing angle. This method is referred to as a space pixel compensation method.

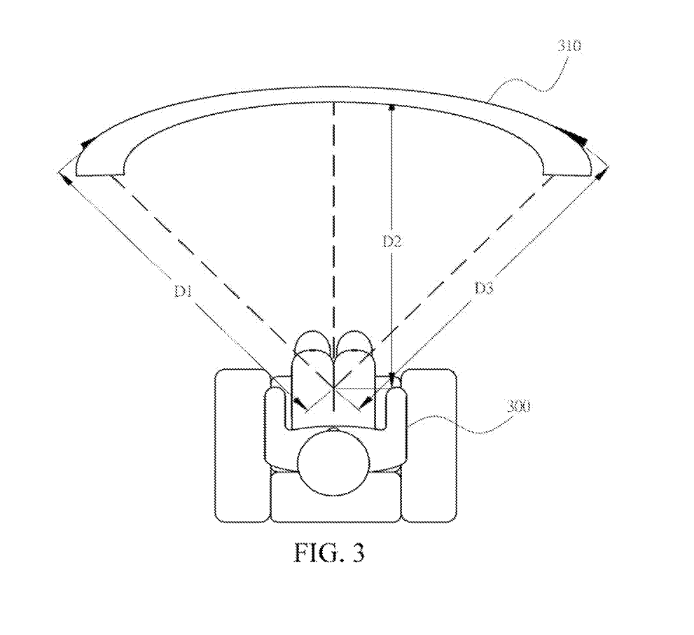

FIG. 3 is a schematic exemplary diagram of relationships between different viewing angles at which a user 300 views a display 310 and different distances to the display 310. Referring to FIG. 3, when a user views a flat display, a distance between the center of a displayed image of the flat display and the user is not equal to distances between two sides of the displayed image and the user, causing distortion of images viewed by the user. Therefore, a curved display 310 is provided. When the user 300 views the curved display 310, because a distance between the center of a displayed image of the curved display 310 and the user 300 is close to distances between two sides of the displayed image of the curved display 310 and the user, images viewed by the user 300 can be more real, and fatigue of viewing can be reduced. Therefore, another method for improving picture quality at a viewing angle is to use a designing manner of a curved display. That is, for specified viewing distances D1, D2, and D3, corresponding display curvatures are calculated. Generally, a curvature of a display is approximately R2000, and a curvature of a television is designed to be approximately R4000. A schematic diagram is shown in FIG. 3. It may be learned that at an appropriate curvature and the viewing distances D1, D2, and D3, each viewing angle of the display 310 is consistent to a central viewing angle, so that picture quality deterioration caused by viewing at different viewing angles is improved. It should be noted that, a description is provided below by using the curved display as an example, but is not limited to using a curved display or a curved display panel. The display device in the present disclosure may be a flat display device.

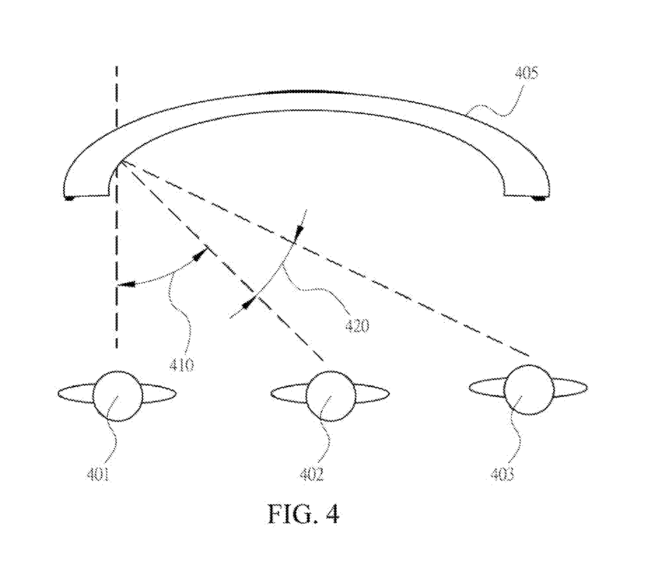

FIG. 4 is another schematic exemplary diagram of relationships between different viewing angles at which users 401, 402, and 403 view a display 405 and different distances to the display 405. Referring to FIG. 4, the conventional curved display 405 is designed for one viewer 402 at a coordinate position (that is, a central position) of a central axis. However, when the television 405 is viewed, usually there may be other viewers in addition to the viewer 401, 402, or 403, and the viewers are not necessarily at the central position, as shown in FIG. 4. Therefore, optimal viewing angles 410 and 420 of the curved television 405 may easily change with positions of the viewers 401, 402, and 403, and optimal picture quality cannot be obtained.

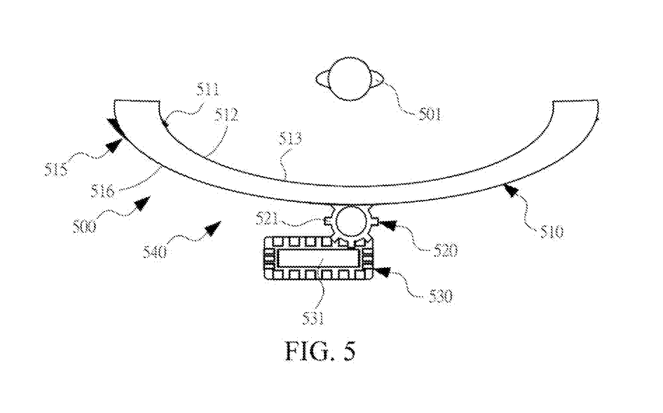

FIG. 5 is a schematic diagram of a curved display device 500 according to an embodiment of the present disclosure. Referring to FIG. 5, in an embodiment of the present disclosure, the curved display device 500 includes: a display panel 510 and an angle adjustment module 540. The display panel 510 includes: a cover 511, having a first curved surface 512; a backplane 515, disposed opposite to the cover 511, and having a second curved surface 516; and an LCD panel 513, disposed between the backplane 515 and the cover 511. The angle adjustment module 540 is coupled to the display panel 510, is configured to adjust a rotation angle of the display panel 510, and includes: a rotation control mechanism unit 520, having a gear 521; and a motor control unit 530, having a motor 531, where the motor 531 is connected to the gear 521.

In an embodiment, the motor 531 in the present disclosure is a step motor.

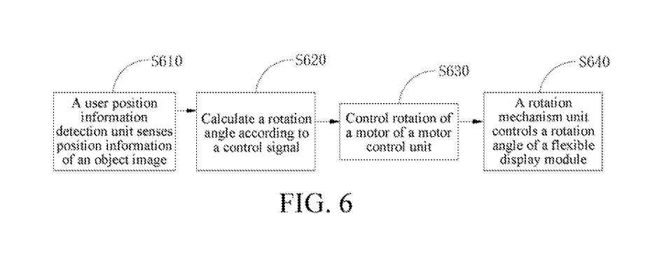

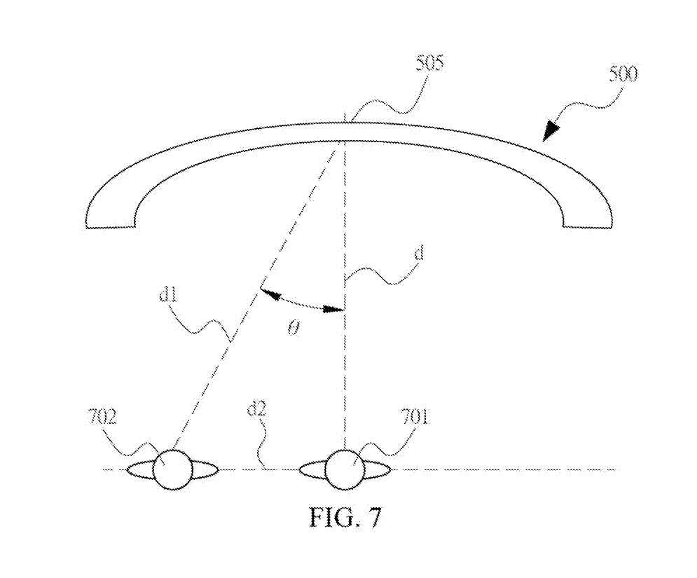

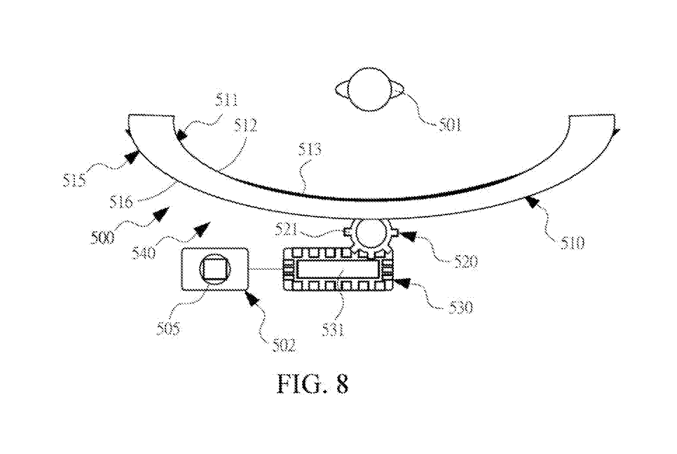

FIG. 6 is a flowchart of a method for controlling a rotation angle of a display device 500 according to an embodiment of the present disclosure; FIG. 7 is a schematic diagram of detecting user positions 701 and 702 by a user position information detection unit 502 according to an embodiment of the present disclosure; and FIG. 8 is a schematic diagram of a display device 500 according to another embodiment of the present disclosure. Referring to FIG. 6, FIG. 7, and FIG. 8, in an embodiment of the present disclosure, the display device 500 includes: a display panel 510 and an angle adjustment module 540. The display panel 510 includes: a cover 511, having a first curved surface 512; a backplane 515, disposed opposite to the cover 511, and having a second curved surface 516; and an LCD panel 513, disposed between the backplane 515 and the cover 511. The angle adjustment module 540 is coupled to the display panel 510, is configured to adjust a rotation angle of the display panel 510, and includes: a rotation control mechanism unit 520, having a gear 521; a motor control unit 530, having a motor 531, where the motor 531 is connected to the gear 521; and a user position information detection unit 502, having a charge-coupled component 505, electrically coupled to the motor control unit 530, and configured to sense an object image.

In an embodiment, the user position information detection unit 502 in the present disclosure includes a rotation angle calculation component configured to automatically analyze an angle θ and users 701 and 702 each deviate from a central plane of the display by the angle, where tan(θ)=d2/d.

In an embodiment, the user position information detection unit 502 in the present disclosure further includes a signal processor configured to analyze distances d2 and the users 701 and 702 deviate from the center of the display by the distances.

In an embodiment, the user position information detection unit 502 in the present disclosure may pre-load a preset distance d between a display plane 505 and the user 701, and a distance d1 between the display plane 505 and the user 702.

In an embodiment, the motor 531 in the present disclosure is a step motor.

In an embodiment, the user position information detection unit 502 in the present disclosure may be a sensor chip or a sensor.

Referring to FIG. 6 and FIG. 8, in an embodiment of the present disclosure, a method for intelligently controlling the rotation angle of the display device 500 includes the following procedures: Provide the display device 500; S610: Generate a control signal according to position information of the object image sensed by the user position information detection unit 502; S620: Calculate a rotation angle according to the control signal; S630: Control rotation of the motor 531 of the motor control unit 530; and S640: Simultaneously control a rotation angle of the flexible display module 510 by means of the rotation mechanism unit 520.

It is understood that in some embodiments, the foregoing method may be implemented by a processor in a computing device, for example, by running an application program. However, it should be emphasized that unless otherwise stated, the foregoing method does not need to be performed according to a definite sequence shown in the figure. Moreover, a plurality of similar procedures (blocks) may be performed in parallel, instead of being performed according to a sequence. Therefore, elements in the foregoing methods are referred to as “procedures (blocks)” rather than “steps” in this specification. It should further be understood that, the foregoing method may be implemented on variations of a computing device.

It may be further understood that, the method in the present disclosure can be implemented in the display device. However, the method in the present disclosure may further be implemented in a similar device or system having components similar to those of the display device, but the components are set in different configurations.

In an embodiment, according to the method in the present disclosure, the step of simultaneously controlling a rotation angle of the display panel 510 by means of a rotation speed of the rotation control mechanism unit 520 includes: connecting to the backplane 515 of the display panel 510 by means of the rotation control mechanism unit 520; adjusting the second curved surface 516 of the backplane 515 by means of rotation of the gear 521; and adjusting a rotation angle of the second curved surface 516, to adjust a rotation angle of the first curved surface 512 of the cover 511.

In an embodiment, according to the method in the present disclosure, the motor 531 is a step motor.

In an embodiment, according to the method in the present disclosure, the user position information detection unit may be a sensor chip or a sensor.

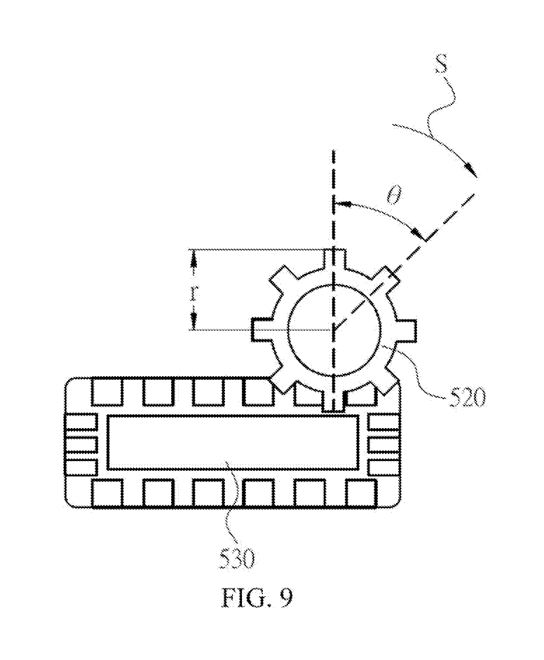

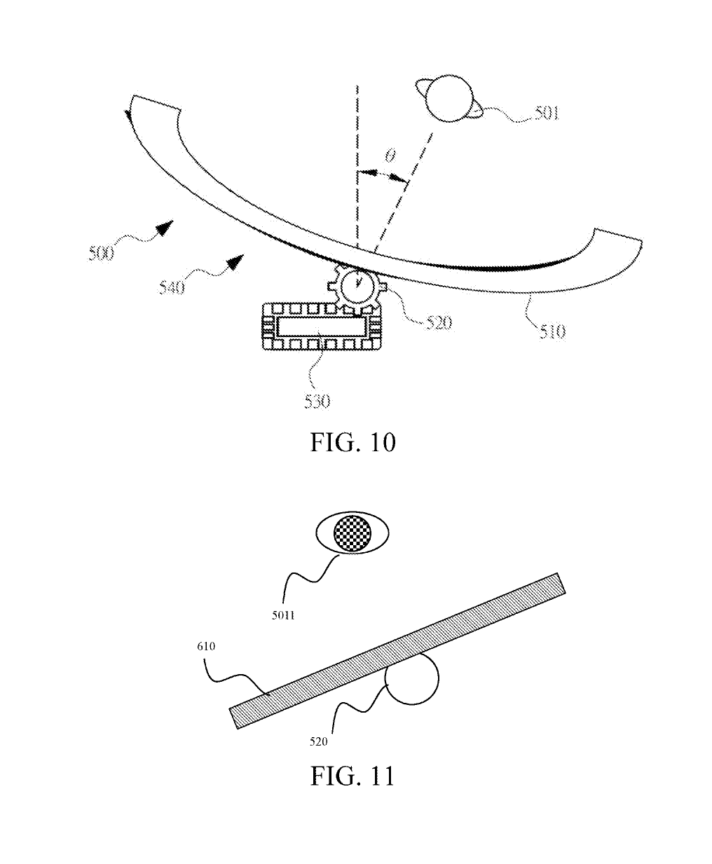

FIG. 9 is a schematic view illustrating operation of a rotation control mechanism unit 520 according to an embodiment of the present disclosure; FIG. 10 is a schematic view illustrating operation of a display device 500 according to an embodiment of the present disclosure; and FIG. 11 is a schematic diagram of a flat display panel 610 according to an embodiment of the present disclosure. Referring to FIG. 7, FIG. 8, FIG. 9, and FIG. 10, in an embodiment of the present disclosure, the display device 500 includes: display panels 510 and 610 and an angle adjustment module 540. The display panel 510 includes: a cover 511, having a first curved surface 512; a backplane 515, disposed opposite to the cover 511, and having a second curved surface 516; and an LCD panel 513, disposed between the backplane 515 and the cover 511. The angle adjustment module 540 is coupled to the display panel 510, is configured to adjust a rotation angle of the display panel 510, and includes: a rotation control mechanism unit 520, having a gear 521; a motor control unit 530, having a motor 531, where the motor 531 is connected to the gear 521; and a user position information detection unit 502, having a charge-coupled component 505, electrically coupled to the motor control unit 530, and configured to sense eye position information of a user.

As shown in FIG. 11, the user position information detection unit 502 may sense a position of a user eye 5011 by sensing a user image, to obtain the eye position information of the user 501. Therefore, the user position information detection unit 502 can more accurately obtain user position information.

In an embodiment, the user position information detection unit 502 in the present disclosure includes a rotation angle calculation component, and is electrically connected to the motor control unit 530 by using a transmission interface, to control a rotation angle θ required by the motor 531.

In an embodiment, after receiving angle information provided by the rotation angle calculation component, the motor control unit 530 in the present disclosure converts the angle information to a relative rotation physical quantity S(r*θ) (the rotation physical quantity=a radius of the gear*an angle and the user deviates from a central plane of the display by the angle), and controls the motor 53 according to the relative rotation physical quantity.

The beneficial effects of the present disclosure is that, the method for controlling a rotation angle of a display can be automatically adjusted according to a change of a user position, so that a rotation angle of a flat or curved display device is adjusted, and picture quality at a large viewing angle can be further improved for a viewer.

A person of ordinary skill in the art may understand that all or some of the processes of the methods in the embodiments may be implemented by a computer program instructing relevant hardware. The program may be stored in a computer readable storage medium. When the program runs, the processes of the methods in the embodiments are performed. The foregoing storage medium may be: a magnetic disk, an optical disc, a read-only memory (ROM), or a random access memory (RAM).

In some embodiments, the display device in the present disclosure includes an LCD panel and a backlight module disposed opposite to each other. The LCD panel mainly includes a CF substrate, a TFT substrate, and a liquid crystal layer sandwiched between the two substrates, where the CF substrate, the TFT substrate, and the liquid crystal layer may form a plurality of pixel units configured in an array. A substrate material of the CF substrate and the TFT substrate may be a glass substrate or a flexible plastic substrate. The CF substrate may be, for example, a glass substrate or a substrate of another material having a CF. The TFT substrate may be, for example, a glass substrate or a substrate of another material having a TFT array. It should be noted that, in some embodiments, the CF and the TFT array may be configured on a same substrate.

The backlight module may emit light penetrating the LCD panel, and display colors by using each pixel unit of the LCD panel, to form an image. In some embodiments, the backlight module may be, for example, a side light incident backlight module, disposed opposite to a display panel (for example, the LCD panel), to form the display device (for example, the LCD device). The backlight module may include a backplane, a light source, a light guide plate, a reflection layer, and an optical film. The backplane is configured to assemble the light source, the light guide plate, the reflection layer, and the optical film. The light source is disposed at one side of the light guide plate and configured to emit light to the light guide plate from the side, and the light is guided by the light guide plate. The reflection layer is formed between the backplane and the light guide plate, and is configured to reflect the light of the light source. The optical film is disposed on the light guide plate, to improve an optical effect.

In some embodiments, the light source may be, for example, a CCFL, an HCFL, an LED, an OLED, an FFL, an EL component, a light bar, a laser light source, or any combination thereof.

In some embodiments, the optical film of the backlight module is, for example, a diffuser, a prism sheet, a TPS, a BEF, a DBEF, a DRPF, or any combination thereof, and is disposed on the light guide plate, to improve an optical effect of light emission of the light guide plate.

Phases such as “in some embodiments” and “in various embodiments” are repeatedly used. Usually, the phases do not refer to a same embodiment; but they can refer to a same embodiment. Words such as “contain”, “have”, and “include” are synonyms, unless other meanings are indicated in the context.

The foregoing descriptions are merely preferred embodiments of the present disclosure, and are not intended to limit the present disclosure in any form. Although the present disclosure has been disclosed above through the preferred embodiments, the embodiments are not intended to limit the present disclosure. Any person skilled in the art can make some equivalent variations or modifications according to the foregoing disclosed technical content without departing from the scope of the technical solutions of the present disclosure to obtain equivalent embodiments. Any simple amendment, equivalent change or modification made to the foregoing embodiments according to the technical essence of the present disclosure without departing from the content of the technical solutions of the present disclosure shall fall within the scope of the technical solutions of the present disclosure.

What is claimed is:

1. A display device, comprising:
a display panel;
a user position information detection unit, comprising an image sensor, electrically coupled to a motor control unit, and configured to sense a user image, to obtain eye position information of a user; and
an angle adjustment module, coupled to the display panel, and configured to adjust a rotation angle of the display panel according to the eye position information of the user.

2. The display device according to claim 1, wherein the display panel is a flat display panel or a curved display panel.

3. The display device according to claim 1, wherein the angle adjustment module comprises:
a rotation control mechanism unit, having a gear; and
a motor control unit, having a motor, wherein the motor is connected to the gear.

4. The display device according to claim 3, wherein the motor is a step motor.

5. The display device according to claim 3, wherein the user position information detection unit comprises a rotation angle calculation component configured to automatically analyze an angle information, and the angle information is an angle and the user deviates from a central plane of the display panel by the angle.

6. The display device according to claim 5, wherein after receiving the angle information provided by the rotation angle calculation component, the motor control unit converts the angle information to a relative rotation physical quantity, and controls the motor according to the relative rotation physical quantity.

7. The display device according to claim 3, wherein the user position information detection unit further comprises a signal processor configured to analyze a distance and the user deviates from the center of the display panel by the distance.

8. The display device according to claim 3, wherein the image sensor is a charge-coupled component.

9. A display device, comprising:
a display panel;
a user position information detection unit, comprising an image sensor, electrically coupled to a motor control unit, and configured to sense a user image, to obtain eye position information of a user, wherein the user position information detection unit comprises a rotation angle calculation component configured to automatically analyze angle information, and the angle information is an angle and the user deviates from a central plane of the display panel by the angle; and
an angle adjustment module, coupled to the display panel, and configured to adjust a rotation angle of the display panel according to the eye position information of the user, wherein the angle adjustment module comprises:
a rotation control mechanism unit, having a gear; and
a motor control unit, having a motor, wherein the motor is connected to the gear, wherein
after receiving the angle information provided by the rotation angle calculation component, the motor control unit converts the angle information to a relative rotation physical quantity, and controls the motor according to the relative rotation physical quantity.

10. The display device according to claim 9, wherein the display panel is a flat display panel or a curved display panel.

11. The display device according to claim 9, wherein the motor is a step motor.

12. The display device according to claim 9, wherein the user position information detection unit further comprises a signal processor configured to analyze a distance and the user deviates from the center of the display panel by the distance.

13. The display device according to claim 9, wherein the image sensor is a charge-coupled component. b
